(19) United States
(12) Patent Application Publication
(10) Pub. No.: US 2022/0355909 A1
(43) Pub. Date: Nov. 10, 2022

(54) LIFTING ASSEMBLY WITH A BOAT LIFT TRANSMISSION DEVICE

(71) Applicant: Vincent Genovese, Ponte Vedra Beach, FL (US)

(72) Inventor: Vincent Genovese, Ponte Vedra Beach, FL (US)

(21) Appl. No.: 17/307,059

(22) Filed: May 4, 2021

(51) Int. Cl. B63C 3/06; B66F 7/02; B66F 7/28

(52) U.S. Cl. CPC B63C 3/06; B66F 7/02; B66F 7/28

(57) ABSTRACT

A lifting device for lifting various vessels includes a two-speed boat lift transmission enables a boat lift to operate at two speeds, i.e. a high speed when the lift is empty or when lowering a boat, and a low speed when lifting the boat. The worm gear drive acts as a speed reducer and it provides locking, so the boat lift cannot back drive. The novel idea of incorporating a harmonic drive differential transmission into the gearbox assembly allows the use of two inputs and ratios, enabling both high speed and low speed operation.

### FIELD OF THE INVENTION

The present invention relates generally to a device for lifting or lowering a boat.

### BRIEF DESCRIPTION OF THE INVENTION

Today all boat lifts only operate at a single speed. Generally, motorized boat lifts are driven by either an open pulley driving a worm gear arrangement mounted to a plate, or a pulley driving an enclosed worm gearbox. I found one patent that was for a double gear reduction gearbox that eliminated the pulleys. The majority of the industry uses a motor—open pulleys—and worm gear either enclosed or open. These systems have two stages of reduction, the pulley set and the worm gear drive.

Currently, the boat lifts only operate at a single speed. While the general user finds that acceptable when lifting or lowering a boat, the owner must deal with long waits to raise or lower a lift when it is empty. This is particularly true when tides have changed and they are returning to the dock/lift, making it necessary to sometimes hold a boat stationary in rough water/wind conditions while waiting for the lift to lower.

There are several patents directed to boat lift apparatus. U.S. Pat. No. 5,970,813, which discloses a drive system that can be used for raising cable supported loads. Disclosed in this arrangement is a motor and belt driven wheel providing a first stage which drives a worm and worm wheel providing a second stage drive system. The worm and worm wheel are connected to a back plate support, which is composed of a high thermal conductivity metal, such as aluminum, to facilitate heat transfer.

Another reference, such as, for example, U.S. Pat. No. 6,397,691, which discloses a double reduction gear drive means and includes two gear reduction mechanisms. The gear drive is a direct drive system which utilizes direct engagement between two adjacently positioned pairs of gears, each of which reduces rotational speed. Again, only one worm gear is used.

While the general user finds that acceptable when lifting or lowering a boat, the owner must deal with long waits to raise or lower a lift when it is empty. This is particularly true when tides have changed and they are returning to the dock/lift, making it necessary to sometimes hold a boat stationary in rough water/wind conditions while waiting for the lift to lower.

The art is replete with various other prior art references describing different designs of boat lifting devices. U.S. Pat. No. 8,800,403, for example, teaches a boat lift drive housing for containing a control box, electric motor and gear head for raising and lowering a boat lift. The housing includes front and rear coaxial openings for access to the gear head. The housing further includes an eyebrow cantilevered over an opening in the housing through which a key switch extends such that the key switch is protected from the sun, rain, snow and ice. The housing further includes a pair of bottom openings, with one bottom housing permitting access to a drive shaft of the electric motor and with the other bottom opening holding a tool for driving the drive shaft of the electric motor. The housing further includes a shape tailored to the control box, electric motor and gear head to minimize extra connections within the housing.

Another prior art reference, such as U.S. Pat. No. 8,727,661, for example, teaches apparatuses and methods for controlling a variable speed boat lift motor. The systems, apparatuses, and methods include a user interface for connection to a variable speed boat lift drive. The user interface transmits a signal to a variable speed boat lift drive that causes the variable speed boat lift drive to rise at a first speed set by a user through the user interface and lower at a second speed set by a user through the user interface.

Still another prior art reference, such as U.S. Pat. No. 7,850,147 teaches a boat lift drive is used for raising and lowering a wide range of boat size. The boat drive is a two-stage worm system and uses a drive motor having a motor shaft driving a first worm and a first worm wheel as a first stage, and driving a second worm and a second worm wheel, as second stage. At least one of said worm shafts has a copper alloy intermediate worm portion. A third stage is provided having a spool driven by the second worm wheels, the spool having a cable disposed thereabout for lifting the boat.

Yet another prior art reference, such as U.S. Pat. No. 6,397,691 teaches a double gear reduction drive mechanism for powering movement of a boat lifting cable for moving of a watercraft upwardly from the water to an elevated position and downwardly from the elevated position of storage to a position in the water therebelow. The device includes two gear reduction mechanisms within the same housing or within separate adjacent housings which can be connected to a drive means for powering rotational movement of a cable spool with at least one boat lift cable attached thereto. This gear drive is a direct drive system since it does not include any belts, chains or pulleys but utilizes direct engagement between two immediately adjacently positioned pairs of gears each of which reduces rotational speed to affect an increase in power, torque and accurate control of movement of boat lifting cable.

Regardless of the drive design, most boat lifts work by driving a tube that a cable winds around. The cable attached to the boat cradle, and winding the cable up lifts the boat. Unwinding the cable lowers the boat. Each side of the boat lift has an independent drive usually. Some smaller lifts only unit one center drive. Alternative designs exist that do no utilize cables, but cable systems are the predominate type.

The present invention aims to solve problems and drawbacks of the aforementioned prior art references by simple and convenient means.

### SUMMARY OF THE INVENTION

A system is a multi-speed boat hoist transmission for lifting and lowering the boat. The system includes a support structure defined by several vertical support beams. The first set of the vertical support beams are interconnected by a first upper support beam. The first upper support beam is formed from steel or aluminum and sits on the first set of the vertical support beams. The first upper support beam is used to support a first shaft used to wind cables for lifting and lowering a cradle used to support the boat positioned thereon.

The second set of the vertical support beams are interconnected by a second upper support beam. The second upper support beam is formed from steel or aluminum and sits on the second set of the vertical support beams. The second upper support beam is used to support a second shaft used to wind cables for lifting and lowering the cradle used to support the boat positioned thereon.

Each of the upper support beams include a first multi-speed boat hoist transmission drive presenting a two-speed differential gearbox and a second multi-speed boat hoist transmission drive presenting a two-speed differential gearbox. Each of the two speed differential gearboxes present two speed drive arrangement of the gearbox that enables two speed operation of the lift the boat at different speeds and at different angles.

Alluding to the above, the cradle is further defined by a pair of cradle beams positioned perpendicularly to the upper support beams. The cradle beams and include a pair of bunks for the boat to rest thereon. Each cradle beams includes a pair of pair of space posts to hold the boat therewithin and prevent frictional engagements between the boat and the cradle beams. All of the aforementioned structural elements are formed from steel or aluminum, or other metals and are not intended to limit the scope of the present invention. Each cradle beams includes a pair of pulleys positioned at terminal ends of each of the cradle beams. The cables are each engage their respective pulleys to lower and lift each cradle beams. The novel idea of incorporating a harmonic drive differential transmission into the gearbox assembly allows the use of two inputs and ratios, enabling both high speed and low speed operation.

Advantage of the present invention is to provide a lifting device for lifting boats utilizing a differential transmission to allow for two inputs to be used alternately, or even at the same time without damaging the drives.

Another advantage of the present invention is to provide a lifting device, which allows for bi-directional operation at a choice of low or high speed.

Still another advantage of the present invention is to provide a lifting device adaptable for using the dual worm gears, which provides locking and prevents back driving.

Yet another advantage of the present invention is to provide a lifting device offering a unique design that is flexible and wherein the input shafts for coupling the motors provided with or without motor flanges or hollow shafts with motor mounting flanges.

Yet another advantage of the present invention is to provide a lifting device offering a unique design that does not permit high speed/high torque lifting, as the gear ratio is significantly different between the two inputs.

Yet another advantage of the present invention is to provide a lifting device offering a unique design that allows for high-speed operation when the lift is empty without impacting its ability to lift slowly at high load/torque conditions when the boat is lifted.

The objects and advantages of the present invention will be more readily apparent from inspection of the following specification, taken in connection with the accompanying drawing, wherein like numerals refer to like parts throughout and in which an embodiment of the present invention is described and illustrated.

The exact manner in which the foregoing and other objects and advantages of the invention are achieved in practice will become more clearly apparent when reference is made to the following detailed description of the preferred embodiments of the invention described in detail in the following specification and shown in the accompanying drawings, where in like reference numbers indicate corresponding parts throughout.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates a perspective view of a lifting assembly with a boat lift transmission device;

FIG. 2 illustrates another perspective view of the lifting assembly without a boat supported thereby;

FIG. 3 illustrates a side view of the lifting assembly without the boat supported thereby;

FIG. 4 illustrates a front view of the lifting assembly without the boat supported thereby;

FIG. 5 illustrates a top view of the lifting assembly without the boat supported thereby;

FIG. 6 illustrates a cross sectional side view of the lifting assembly without the boat supported thereby;

FIG. 7 illustrates a cross sectional view of the gear box of the present invention;

FIG. 8 illustrates a perspective cross sectional view of the gear box shown in FIG. 7; and

FIG. 9 illustrates a perspective and partial view of the mechanical engagement between the worm gear shafts, the output shafts, the worm gears defined in the worm gear shafts a set of the bearings, and the worm gear wheel positioned around the housing.

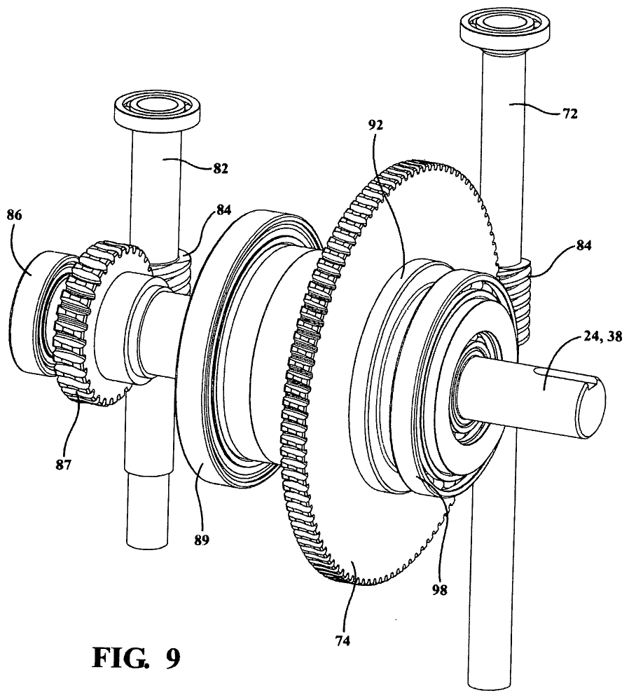

### DETAILED DESCRIPTION OF THE INVENTION

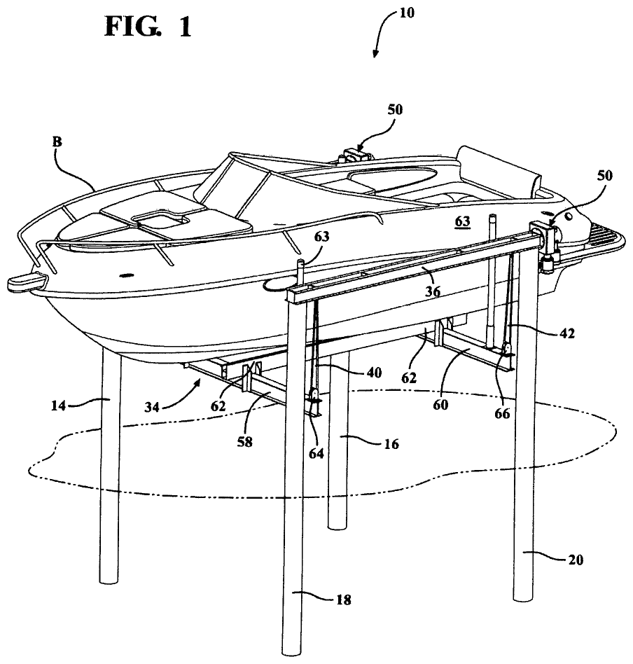

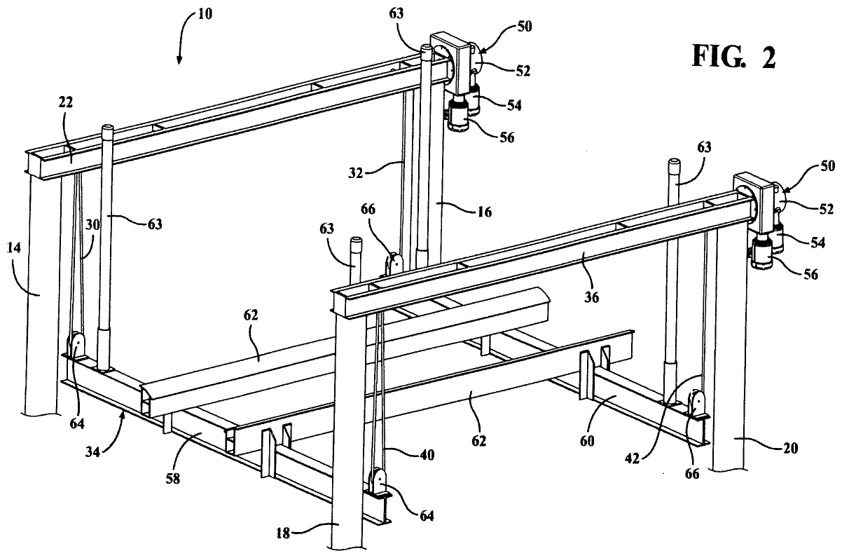

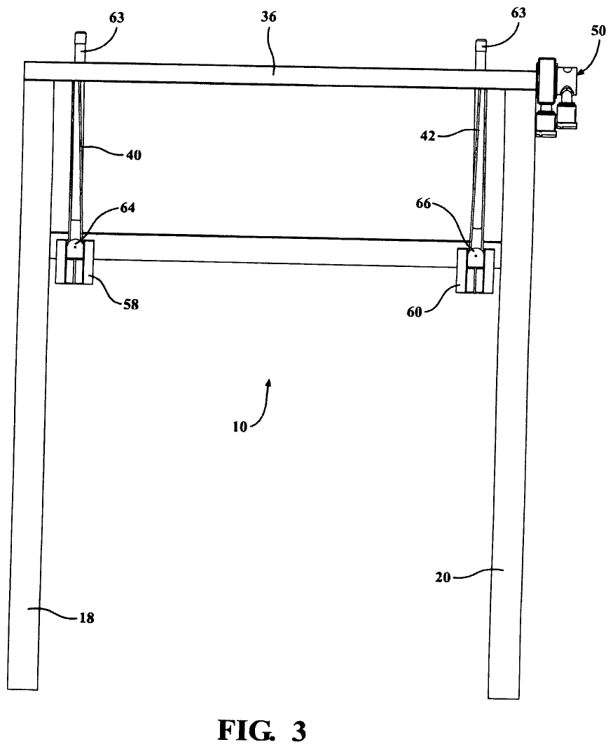

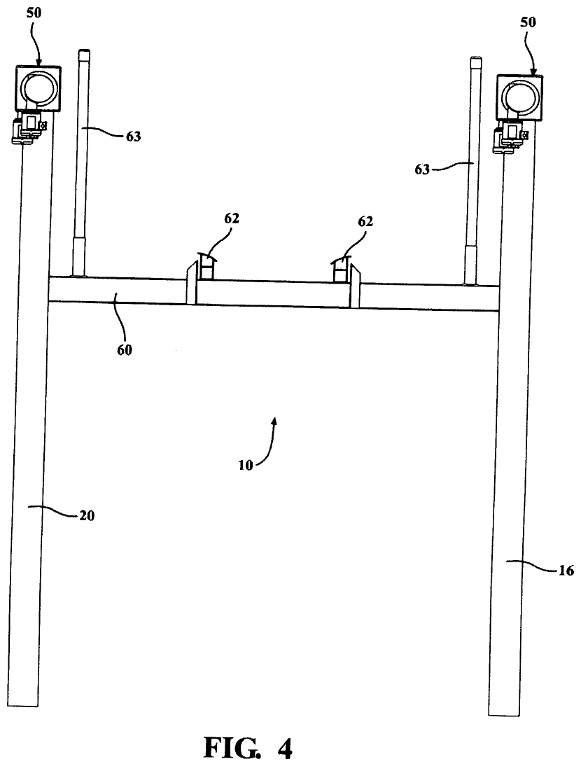

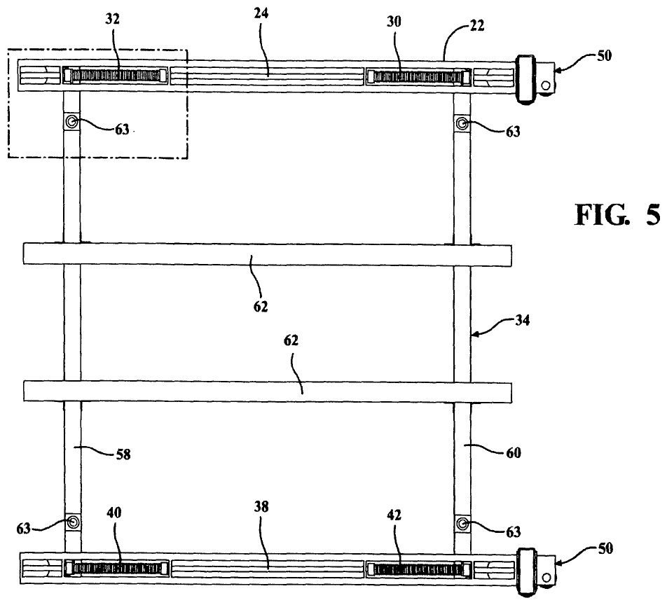

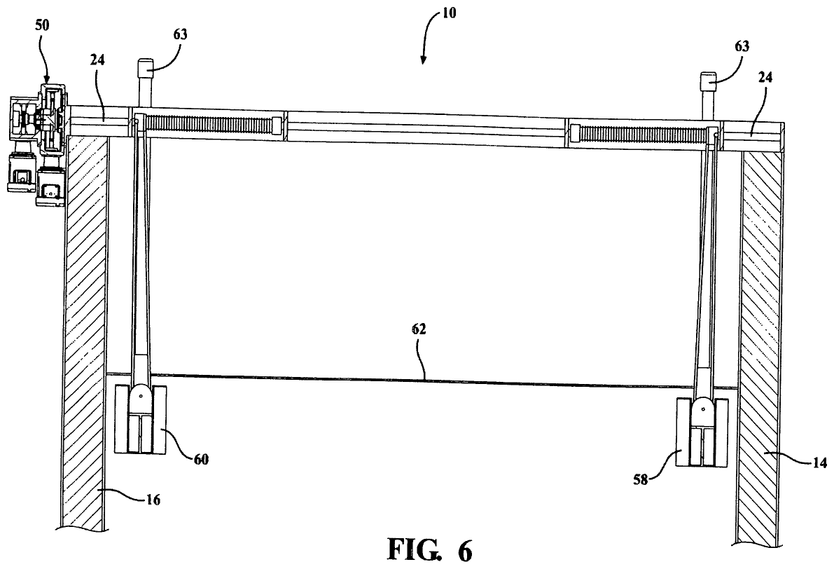

Referring to the FIGS. 1 through 6, a lifting assembly of a multi-speed boat hoist transmission for lifting and lowering a boat (the system), is generally shown at 10. Alluding to the above, for purposes of this patent document, the terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.”

Additionally, as used herein, the singular forms “a,” “an,” and “the” include plural referents unless the context clearly dictates otherwise. Thus, for example, the term “module” is intended to mean one or more modules or a combination of modules. Furthermore, as used herein, the term “based on” includes based at least in part on. Thus, a feature that is described as based on some cause, can be based only on that cause, or based on that cause and on one or more other causes.

It will be apparent that multiple embodiments of this disclosure may be practiced without some or all of these specific details. In other instances, well-known process operations have not been described in detail in order not to unnecessarily obscure the present embodiments. The following description of embodiments includes references to the accompanying drawing. The drawing shows illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

Referring back to FIGS. 1 through 6, the system 10 is a multi-speed boat hoist transmission for lifting and lowering the boat. The system 10 includes a support structure defined by several vertical support beams 14, 16, 18, and 20. The first set of the vertical support beams 14 and 16 are interconnected by a first upper support beam 22. The first upper support beam 22 is formed from steel or aluminum and sits on the first set of the vertical support beams 14 and 16. The first upper support beam 22 is used to support a first shaft 24 used to wind cables 30 and 32 for lifting and lowering a cradle, generally indicated at 34 used to support the boat B positioned thereon.

The second set of the vertical support beams 18 and 20 are interconnected by a second upper support beam 36. The second upper support beam 36 is formed from steel or aluminum and sits on the second set of the vertical support beams 18 and 20. The second upper support beam 36 is used to support a second shaft 38 used to wind cables 40 and 42 for lifting and lowering the cradle 34 used to support the boat B positioned thereon.

Alluding to the above, each of the upper support beams 22 and 36 include a first multi-speed boat hoist transmission drive, generally indicated at 50 presenting a two-speed differential gearbox 52 and a second multi-speed boat hoist transmission drive, generally indicated at 54 presenting a two-speed differential gearbox 56. Each of the two speed differential gearboxes 52 and 56 present two speed drive arrangement of the gearbox that enables two speed operation of the lift the boat at different speeds and at different angles.

Referring back to the cradle 34, it is further defined by a pair of cradle beams 58 and 60 positioned perpendicularly to the upper support beams 22 and 36. The cradle beams 58 and 60 include a pair of bunks 62 for the boat to rest thereon. Each cradle beams 58 and 60 includes a pair of space posts 63 to hold the boat B therewithin and prevent frictional engagements between the boat B and the cradle beams 58 and 60. All of the aforementioned structural elements are formed from steel or aluminum, or other metals and are not intended to limit the scope of the present invention. Each cradle beams 58 and 60 includes a pair of pulleys 64 and 66 positioned at terminal ends of each of the cradle beams 58 and 60. The cables 30 and 32 are each engage their respective pulleys 64 and 66 to lower and lift each cradle beams 58 and 60.

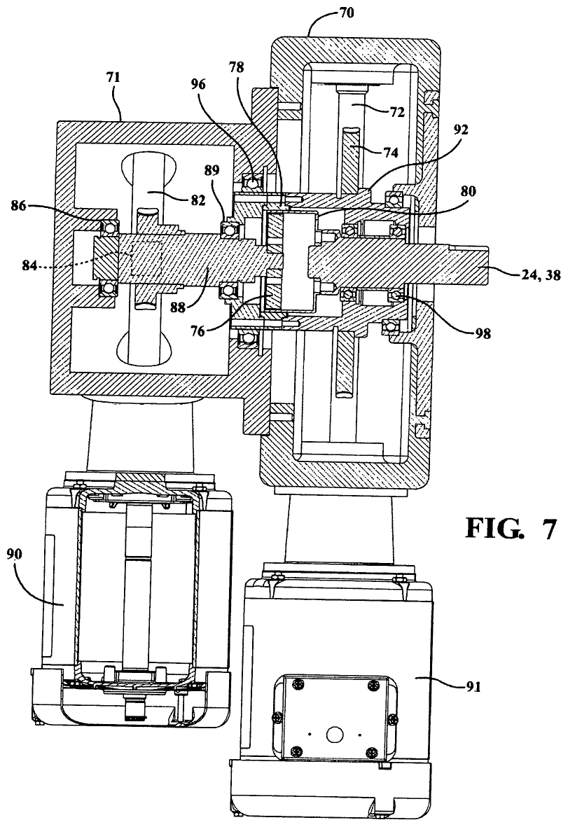

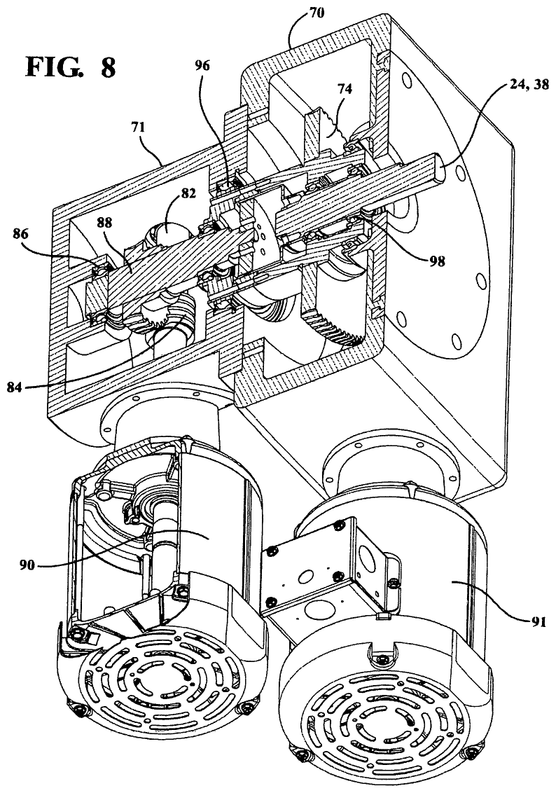

Referring to FIGS. 7 and 8, each of the multi-speed boat hoist transmission drive presenting the two-speed differential gearbox, includes a first housing 70 and a second housing 71. A first worm gear shaft 72 extends through the housing 70 through input, differential side. This shaft 72 drives a worm gear wheel 74, as best shown in FIG. 7 that drives the input to the high ration differential. The shaft 72 ultimately drives a wave generator 76 of the harmonic gearset, which includes at least three parts such as a circular spline or a harmonic circular spline 78, a flex spline 80, and the wave generator 76, as best shown in FIG. 7.

Referring back to FIG. 7, the following input will be used to cause low speed, high torque movement. For example, the rations provided herebelow are used for illustration purposes and are not intended to limit the scope of the present invention. If a worm gear ration is 50:1, and a differential ration is 100:1, and if a motor RPM equals to 1800, then the output speed of the shaft 24 or 38 will equal to 0.36 RPM (1800×1/50×1/100), wherein motor torque is multiplied by 5000 times and the input is used when raising the boat B at high torque and low speed. A worm gear 84 can be used as a separate gear mounted on the first worm gear shaft 72 or a second worm gear shaft 82 or cut into any of the worm gear shafts 72 and 82. As best shown in FIG. 8, the worm gear 84 and the second worm gear shaft 82 are integrally form therebetween. A first bearing 86 is an outboard bearing supporting a differential input shaft 88.

Referring to FIG. 7, the first worm gear shaft 72 (positioned on input and high-speed side) drives the worm gear wheel 74, wherein the input is used to cause high speed movement. For example, the rations provided herebelow are used for illustration purposes and are not intended to limit the scope of the present invention. If a worm gear ration is 30:1, and a differential ration is 100:1, and if a motor RPM equals to 1800, then the output speed of the shaft 24 or 38 will equal to 60.6 RPM (1800×1/30×101/100), wherein motor torque is multiplied by 29.7 times and the input is used when lowering the boat B at high speed, lowering an empty lift at a high speed, and raising an empty lift at a high speed. The worm gear in this case is self-locking and prevents any of motors 90 or 91 from back driving. The worm gear wheel 74 is also used to drive a housing 92. The housing 92 is used to be rotated with the worm gear wheel 74 and drives the circular spline 74 of the harmonic differential gear set. A pair of bearings 96 and 98 are used to support the harmonic differential.

The novel idea of incorporating the harmonic drive differential transmission into the gearbox assembly allows the use of two inputs and ratios, enabling both high speed and low speed operation. This differential transmission including the harmonic drive gearing assembly uses a first input and a second input whereby as the first input is used, the gearbox assembly moves at a first speed and when the second input is used the gearbox assembly moves at a second speed which is higher than the first speed. As the circular spline of the harmonic is attached to the housing or integral with it, it too is held stationary. In the case of an RV Drive, its OD will be held stationary, and in the case of a planetary drive, the ring gear will be held stationary.

The second input worm gear drives the shaft in the bearings. In one option, the outboard bearing is mounted in the case and the right hand, or inboard bearing, is mounted in the differential transmission which also can be rotated during high speed operation. The shaft drives the harmonic drive wave generator (an elliptical bearing). It equally can drive the input to an RV drive or sun gear of a planetary drive. The harmonic drive/RV drive/planetary gearing further reduces the speed and drives the output shaft. The output shaft is coupled to the tube that coils the lift cable. During low-speed operation using the first input, the overall ratio of the system may for example be 50:1 (worm) 100:1 Harmonic=5000:1 output. Many ratios can be chosen based upon the desired speed and output torque capabilities. Referring back to the second input, i.e. high speed operation, the motor 90 or 91 drives the input 2 worm gear. In this case, the first input is stationary, which in turn holds other attached components stationary. The second input worm gear drives the differential housing. In turn, the housing will drive the harmonic gearing circular spline (or RV OD or ring gear of a planetary).

The differential gearing drives the output shaft. During high-speed operation with the first input locked and using the motor at the second input, overall speed reduction is less and the output is speed faster. For example, if the worm gear is 50:1 and the harmonic ratio is nominally 100:1, (when used as a reducer with the input on the wave generator) the overall ratio would be 50:1×101/100=50.1:1.

The worm gear drive provides two functions: it acts as a speed reducer and provides locking, so the boat lift cannot back drive. Locking is important, as you would not want the boat to drop into the water. Worm gears are inherently self-locking and will not back drive. Regardless of the drive design, most boat lifts work by driving a tube that a cable winds around. The cable attached to the boat cradle, and winding the cable up lifts the boat. Unwinding the cable lowers the boat. Each side of the boat lift has an independent drive usually. Some smaller lifts only unit one center drive. Alternative designs exist that do no utilize cables, but cable systems are the predominate type. The present invention can be applied to either and can be retrofitted to existing systems as well. Utilizing a differential transmission will allow for two inputs to be used alternately, or even at the same time without damaging the drives. It will also allows for bi-directional operation at a choice of low or high speed. Using the dual worm gears provides locking and prevents back driving.

The design is flexible and input shafts for coupling the motors with or without the motor flanges can be provided, or hollow shafts with motor mounting flanges can be provided. This design of the present invention does not permit high speed/high torque lifting, as the gear ratio is significantly different between the two inputs.

The design of the present invention allows for high speed operation when the lift is empty without impacting its ability to lift slowly at high load/torque conditions. The design of the present invention also allows for high speed lowering of the boat without impacting its ability to lift slowly at high load/torque conditions as the boat is being lifted.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A multi-speed boat hoist transmission device for lifting and lowering a boat, said multi-speed boat hoist transmission comprising, said multi-speed boat hoist transmission device comprising:
a first surface for holding a boat;
a second surface connected to said first surface with said first surface movable relative said second surface;
at least one gearbox assembly connected to said second surface, said at least one gearbox assembly incorporating a harmonic drive differential transmission allows use of two inputs and ratios, thereby enabling both high speed and low speed operation of said multi-speed boat hoist transmission device to enable to operate at two speeds a high speed when said first surface is empty or when lowering the boat, and low speed when lifting the boat positioned on the first surface.

2. The multi-speed boat hoist transmission device for lifting vessels at multiple speeds of claim 1, wherein said first surface is further defined by several vertical support beams with a first set of said vertical support beams being interconnected by a first upper support beam.

3. The multi-speed boat hoist transmission device for lifting vessels at multiple speeds of claim 1, wherein said first upper support beam used to support a first shaft used to wind a pair of cables for lifting and lowering a cradle to support the boat positioned thereon.

4. The multi-speed boat hoist transmission device for lifting vessels at multiple speeds of claim 3, wherein a second set of said vertical support beams is interconnected by a second upper support beam used to support a second shaft used to wind a second set of cables for lifting and lowering said cradle used to support the boat positioned thereon.

5. The multi-speed boat hoist transmission device for lifting vessels at multiple speeds of claim 4, wherein said support beams each including a first multi-speed boat hoist transmission drive presenting a two-speed differential gearbox and a second multi-speed boat hoist transmission drive presenting a second two-speed differential gearbox.

6. The multi-speed boat hoist transmission device for lifting vessels at multiple speeds of claim 5, wherein each of said two speed differential gearboxes present two speed drive arrangement of said gearbox that enables two speed operation thereby lifting the boat at different speeds and at different angles.

7. The multi-speed boat hoist transmission device for lifting vessels at multiple speeds of claim 6, wherein said cradle is further defined by a pair of cradle beams positioned perpendicularly to said upper support beams, said cradle beams include a pair of bunks for the boat to rest thereon.

8. The multi-speed boat hoist transmission device for lifting vessels at multiple speeds of claim 5, wherein each said cradle beams includes a pair of space posts to hold the boat therewithin and prevent frictional engagements between the boat and said cradle beams.

9. The multi-speed boat hoist transmission device for lifting vessels at multiple speeds of claim 8, wherein each said cradle beams includes a pair of pulleys positioned at terminal ends of each of said cradle beams wherein each of said cables are each engage their respective pulleys to lower and lift each said cradle beams.

10. The multi-speed boat hoist transmission device for lifting vessels at multiple speeds of claim 9, wherein each of said multi-speed boat hoist transmission drive presenting said two-speed differential gearbox including a first housing and a second housing wherein a first worm gear shaft extends through one of said housings and drives a worm gear wheel that drives the input to the high ration differential.

11. The multi-speed boat hoist transmission device for lifting vessels at multiple speeds of claim 6, wherein said shaft drives a wave generator of a harmonic gearset, which also includes a circular spline or a harmonic circular spline and a flex spline.

12. A multi-speed boat hoist transmission device for lifting and lowering a boat, said multi-speed boat hoist transmission comprising, said multi-speed boat hoist transmission device comprising:
several vertical support beams with a first set of said vertical support beams being interconnected by a first upper support beam, said first upper support beam used to support a first shaft used to wind a pair of cables for lifting and lowering a cradle to support the boat positioned thereon;
wherein a second set of said vertical support beams is interconnected by a second upper support beam used to support a second shaft used to wind a second set of cables for lifting and lowering said cradle used to support the boat positioned thereon;
said support beams each including a first multi-speed boat hoist transmission drive presenting a two-speed differential gearbox and a second multi-speed boat hoist transmission drive presenting a second two-speed differential gearbox;
a second surface connected to said first surface with said first surface movable relative said second surface;
wherein said cradle is further defined by a pair of cradle beams positioned perpendicularly to said upper support beams, said cradle beams include a pair of bunks for the boat to rest thereon;
wherein each said cradle beams includes a pair of space posts to hold the boat therewithin and prevent frictional engagements between the boat and said cradle beams;
wherein each said cradle beams includes a pair of pulleys positioned at terminal ends of each of said cradle beams wherein each of said cables are each engage their respective pulleys to lower and lift each said cradle beams;
at least one gearbox assembly connected to said second surface, said at least one gearbox assembly incorporating a harmonic drive differential transmission allows use of two inputs and ratios, thereby enabling both high speed and low speed operation of said multi-speed boat hoist transmission device to enable to operate at two speeds a high speed when said first surface is empty or when lowering the boat, and low speed when lifting the boat positioned on the first surface;
wherein each of said two speed differential gearboxes present two speed drive arrangement of said gearbox that enables two speed operation thereby lifting the boat at different speeds and at different angles;
wherein each of said multi-speed boat hoist transmission drive presenting said two-speed differential gearbox including a first housing and a second housing wherein a first worm gear shaft extends through one of said housings and drives a worm gear wheel that drives the input to the high ration differential; and
wherein said shaft drives a wave generator of a harmonic gearset, which also includes a circular spline or a harmonic circular spline and a flex spline.
